(19) United States
(12) Patent Application Publication
(10) Pub. No.: US 2012/0195356 A1
(43) Pub. Date: Aug. 2, 2012

(54) RESOURCE USAGE CONTROL FOR REAL TIME VIDEO ENCODING

(75) Inventors: Feng YI, San Jose, CA (US); Chris Y. CHUNG, Sunnyvale, CA (US); Hsi-Jung WU, San Jose, CA (US); David CONRAD, Sunnyvale, CA (US); Jiefu ZHAI, San Jose, CA (US)

(73) Assignee: APPLE INC., Cupertino, CA (US)

(21) Appl. No.: 13/018,363

(22) Filed: Jan. 31, 2011

(51) Int. Cl. H04N 7/26; H04B 17/00

(52) U.S. Cl. 375/224; 375/240.02; 375/240.03; 375/E07.126; 375/E07.139

(57) ABSTRACT

A video coding system and method that dynamically controls coding parameters to satisfy a resource usage requirement. A resource controller may set parameters or parameter thresholds to change the coding complexity of the video coding system and to effectuate a change in the resource usage rate. Parameters may include the frame rate, the frame resolution, the bit rate, or pixel block sizes. A parameter or parameter threshold adjustment may be based on system resource data, for example, power consumption, CPU usage, fan speed, battery status, input video statistics, coding latency, and other video encoder internal states.

### BACKGROUND

Aspects of the present invention relate generally to the field of video processing, and more specifically to dynamically setting coding parameters to adjust resource usage.

In conventional video coding systems, an encoder may code a source video sequence into a coded representation that has a smaller bit rate than does the source video and thereby achieve data compression. Video coding systems initially may separate a source video sequence into a series of frames, each frame representing a still image of the video. A frame may be further divided into blocks of pixels. Each frame of the video sequence may then be coded on a block-by-block basis according to any of a variety of different coding techniques. For example, using predictive coding techniques, some frames in a video stream may be coded independently (intra-coded I-frames) and some other frames may be coded using other frames as reference frames (inter-coded frames, e.g., P-frames or B-frames). P-frames may be coded with reference to a single previously coded frame and B-frames may be coded with reference to a pair of previously coded frames. Previously coded frames, also known as reference frames, may be temporarily stored by the encoder for future use in inter-frame coding. The resulting compressed sequence (bitstream) may be transmitted to a decoder via a channel. To recover the video data, the bitstream may be decompressed at the decoder, by inverting the coding processes performed by the encoder, yielding a received decoded video sequence. In some circumstances, the decoder may acknowledge received frames and report lost frames.

Conventional video coding systems often operate in processing environments in which the resources available for coding or decoding operations vary dynamically. Modern communications networks provide variable bandwidth channels to connect an encoder to a decoder. Further, processing resources available at an encoder or a decoder may be constrained by hardware limitations or power consumption objectives that limit the complexity of analytical operations that can be performed for coding or decoding operations. When sufficient resources are unavailable, video coding systems may wait until they are available in order to maintain the coding rate or quality, causing an undesirable delay. However, real-time video coding systems may not have the ability to pause coding operations until system resources are available. Accordingly, there is a need in the art for dynamically controlling various encoding parameters to meet the resource usage requirement.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified block diagram illustrating components of an exemplary video coding system according to an embodiment of the present invention.

FIG. 2 is a simplified block diagram illustrating components of an exemplary video encoder according to an embodiment of the present invention.

FIG. 3 is a simplified block diagram illustrating components of an exemplary coding engine according to an embodiment of the present invention.

FIG. 4 is a simplified flow diagram illustrating a method of adjusting coding parameters to control resource usage according to an embodiment of the present invention.

FIG. 5 is a simplified flow diagram illustrating a method of setting coding parameter thresholds according to an embodiment of the present invention.

### DETAILED DESCRIPTION

Embodiments of the present invention provide a video coding system that dynamically controls coding parameters to satisfy a resource usage requirement. A resource controller may set parameters or parameter thresholds relating to the frame rate, the frame resolution, the bit rate, various mode decision parameters such as motion search range and precision, block sizes, and early termination methods in order to effectuate a change in the resource usage rate. An encoder may determine a parameter or threshold adjustment based on the current parameter settings and the current resource usage rates, for example the current power consumption, CPU usage, fan speed or battery status, or based on other system data, including for example, the statistics of the input video data, the coding latency, and the video encoder internal states. The resource controller may calculate a new parameter value or parameter threshold for the encoder. A parameter value or encoding threshold that decreases the coding complexity or coding latency of the encoder operations may alter the resource usage rate for the decoder.

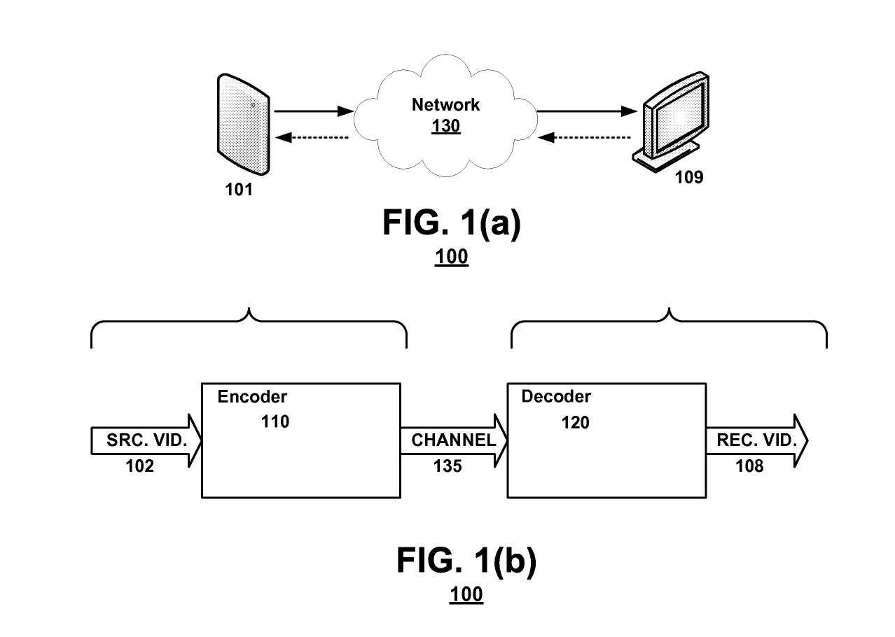

FIG. 1(a) illustrates a simplified block diagram of a video coding system 100 according to an embodiment of the present invention. The system 100 may include a plurality of devices 101, 109 interconnected via a network 130. The devices 101, 109 each may capture video data at a local location and code the video data for transmission to another device via the network 130. Each device 101, 109 may receive the coded video data of the other device from the network 130, decode the coded data and display the recovered video data. Video devices may include personal computers (both desktop and laptop computers), tablet computers, handheld computing devices, computer servers, media players and/or dedicated video conferencing equipment. The network 130 represents any number of networks that may convey coded video data between the devices 101, 109, including for example wireline and/or wireless communication networks for example telecommunications networks, local area networks, wide area networks and/or the Internet. The communication network 130 may exchange data in circuit-switched or packet-switched channels.

FIG. 1(b) further illustrates a functional block diagram of a video encoder and decoder 110, 120 operable within the system 100. Specifically, FIG. 1(b) illustrates a video encoder 110 for device 101 and a video decoder 120 for device 109. The encoder 110 may receive an input source video sequence 102 from a video source device 101. As will be further explained, the encoder 110 may then process the input source video sequence 102 as a series of frames and dynamically adjust the coding operations to optimize resource usage. For example, the encoder may respond to changes in the video coding system 100 resource availability by dynamically adjusting coding parameters or parameter thresholds including, for example, frame rate, frame resolution, or the size of the pixel block selected for coding.

Using predictive coding techniques, the encoder 110 may then compress the processed video data using a prediction technique that exploits spatial and/or temporal redundancies in the input source video sequence 101. The resulting compressed sequence may occupy less bandwidth than the source video sequence when it is transmitted to a decoder 120 via a channel 135. The channel 135 may be a transmission medium provided by communications or computer networks, for example either a wired or wireless network.

The decoder 120 may receive the compressed video data from the channel 135 and prepare the video for display on the computing device 109 by inverting coding operations performed by the encoder 110. The decoder 120 further may prepare the decompressed video data for the device 109 by filtering, de-interlacing, scaling or performing other processing operations on the decompressed sequence that may improve the quality of the video displayed. The processed video data 108 may be displayed on a screen or other display of the device 109. Alternatively, processed video data may be stored in a storage device (not shown) for later use.

As shown in FIG. 1(b), the functional blocks support video coding and decoding in one direction only. For bidirectional communication, an encoder 110 and decoder 120 may each be implemented on the devices 101, 109 such that each device may capture video data at a local location and code the video data for transmission to the other device via the channel 135.

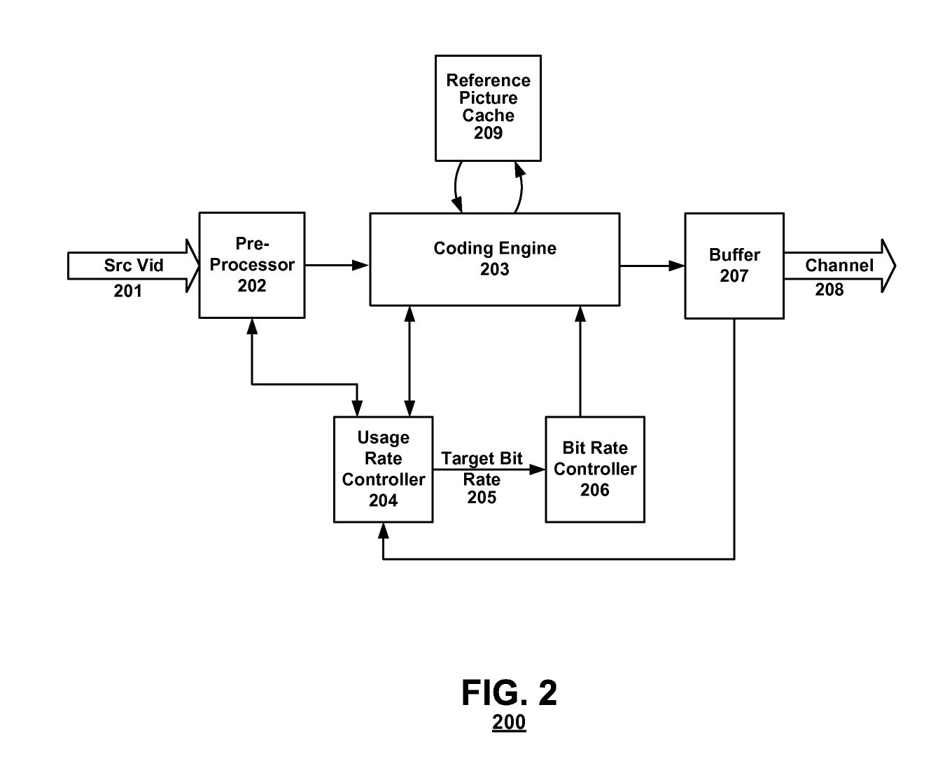

FIG. 2 is a simplified block diagram illustrating components of an exemplary video encoder 200 according to an embodiment of the present invention. As shown, encoder 200 may include a pre-processor 202, a coding engine 203 with a reference picture cache 209, a usage rate controller 204, a bit rate controller 206, and a video data buffer 207.

The pre-processor 202 may perform video processing operations to condition the source video sequence 201 to render bandwidth compression more efficient or to preserve image quality in light of anticipated compression and decompression operations. The pre-processor 202 may include an array of filters (not shown) such as de-noising filters, sharpening filters, smoothing filters, bilateral filters and the like that may be applied dynamically to the source video based on characteristics observed within the video. The pre-processor 202 may include its own controller (not shown) to review the source video data from the camera and select one or more of the filters for application. The pre-processor 202 may additionally separate the source video sequence 201 into a series of frames, if not already done, each frame representing a still image of the video.

The coding engine 203 may receive the processed video data from the pre-processor 202. The coding engine 203 may operate according to a predetermined protocol, such as H.263, H.264, or MPEG-2. The coded video data, therefore, may conform to a syntax specified by the protocol being used. In its operation, the coding engine 203 may perform various compression operations, including predictive coding operations that exploit temporal and/or spatial redundancies in the source video sequence 201 in accordance with the parameters or parameter thresholds set by the controller 204.

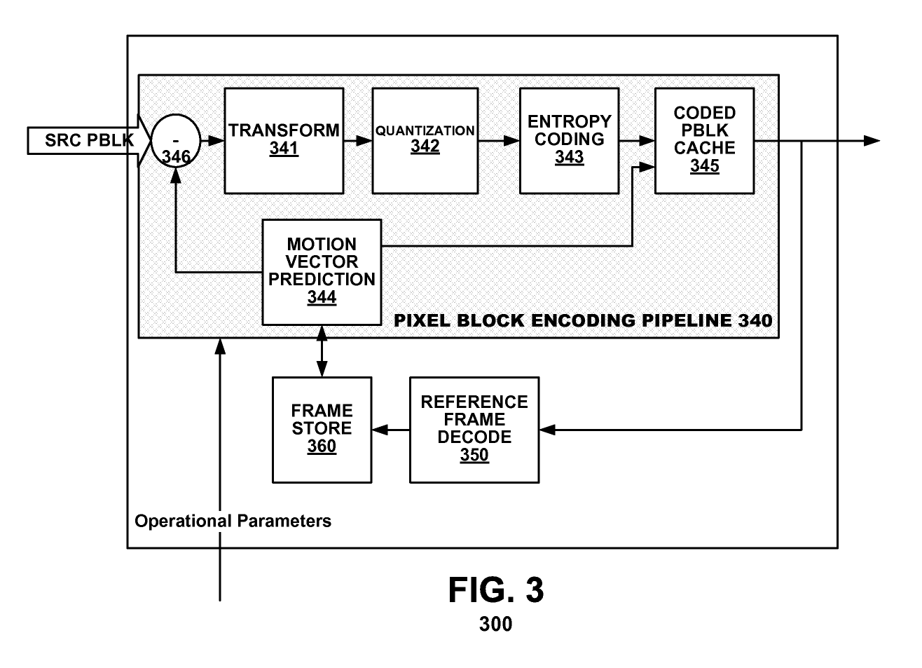

FIG. 3 is a simplified diagram of a coding engine 300 according to an embodiment of the present invention. The coding engine 300 may include a pixel block encoding pipeline 340 further including a transform unit 341, a quantizer unit 342, an entropy coder 343, a motion vector prediction unit 344, a coded pixel block cache 345, and a subtractor 346. The transform unit 341 may convert the incoming pixel block data into an array of transform coefficients, for example, by a discrete cosine transform (DCT) process or wavelet process. The transform coefficients can then be sent to the quantizer unit 342 where they are divided by a quantization parameter. The quantized data may then be sent to the entropy coder 343 where it may be coded by run-value or run-length or similar coding for compression. The coded data can then be sent to the motion vector prediction unit 344 to generate predicted pixel blocks. The motion vector prediction unit 344 may also supply engine parameters such as parameters for prediction type and motion vectors for coding. The subtractor 346 may compare the incoming pixel block data to the predicted pixel block output from motion vector prediction unit 344, thereby generating data representative of the difference between the two blocks. However, non-predictively coded blocks may be coded without comparison to the reference pixel blocks. Coded pixel blocks may then be temporarily stored in the pixel block cache 345 until they can be output from the encoding pipeline 340. The coding engine 300 may further include a reference frame decoder 350 that decodes the coded pixel blocks output from the encoding pipeline 340 by reversing the entropy coding, the quantization, and the transforms. The decoded frames may then be stored in a frame store 360 for use with the motion vector prediction unit 344. Operational parameters for the encoding pipeline, including a quantization parameter, frame rate, frame resolution, bit rate, mode decision parameters including a motion search range and precision, pixel block sizes, and early termination modes may be set by an controller setting parameters for the coding engine 300.

As shown in FIG. 2, the usage rate controller 204 may set operational parameters for the encoder 200. The usage rate controller 204 may receive and evaluate source video data 201 from the source device, and feedback signals from the pre-processor 202, coding engine 203 and video data buffer 207 including, for example, statistics concerning the input video, the status of video system components such as power consumption, CPU usage, fan speed, and battery status, the encoding time and other information reflecting the internal state of the encoder 200. Based on those inputs, the usage rate controller 204 may control operation of the pre-processor 202, the coding engine 203, or the bit rate controller 206 by setting operational parameters of each. The usage rate controller 204 may change a single parameter or a plurality of parameters to achieve the resource usage change. For example, with respect to the coding engine 203, the usage rate controller 204 may set parameter thresholds for coding mode decisions that may select a coding technique for a pixel block (e.g., I-, P- or B-coding), refresh rate thresholds for error resiliency, quantization parameters to be used for coefficient truncation, the sizes of images to be coded and the like. For example, each frame may be parsed into a predetermined number of “pixel blocks,” or regular arrays of pixels of a variable size, typically 4×4, 8×8 or 16×16 pixel arrays. A parameter set by the usage rate controller 204 may select the pixel block size or may set the thresholds according to which the pixel block size selection is made.

With respect to the pre-processor 202, the usage rate controller 204 may set parameters setting the types of filtering to be performed by the pre-processor 202, the frame resolution, and relative strengths of filtering that should be applied and parameters of scaling operations. With respect to the bit rate controller 206, the usage rate controller 204 may set a target bit rate. The bit rate controller 206 may then set additional operating parameters of the coding engine 203, for example, a quantization parameter according to the target bit rate. The encoder parameters and thresholds may be set for a single pixel block, multiple pixel blocks, a single frame, or a sequence of frames.

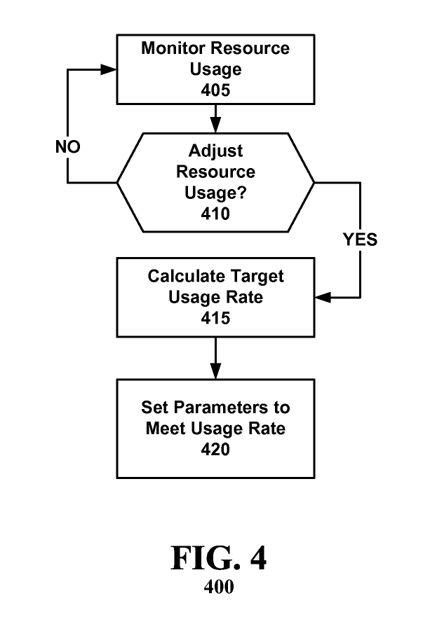

FIG. 4 is a simplified flow diagram illustrating a method 400 of adjusting coding parameters to control resource usage according to an embodiment of the present invention. An encoder may determine a parameter or threshold adjustment based on current resource usage, for example the current power consumption, CPU usage, fan speed or battery status. The encoder may monitor the resource usage of the video encoding system (405). Such monitoring may be accomplished by receiving current resource usage data and calculating a change in the system conditions based on the received data. The encoder may continue to monitor the system resource usage until a change in the system conditions is detected (block 410). If the change in conditions indicates that the encoder should change the resource usage rate for coding video data, a target resource usage rate may then be calculated (415). Once the target usage rate is calculated, coding parameters may be set to adjust the encoder's resource usage (block 420) by changing the coding complexity or encoder latency.

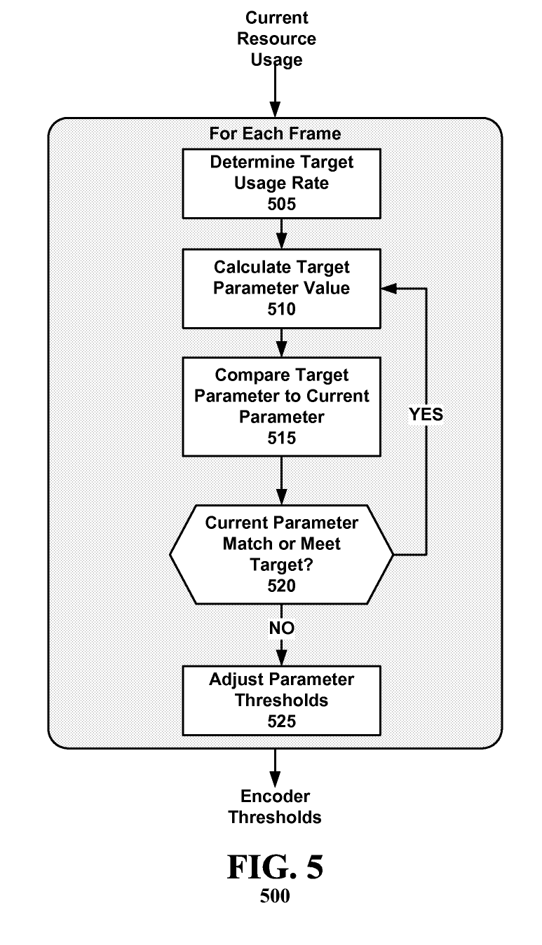

FIG. 5 is a simplified flow diagram illustrating a method 500 of setting coding parameter thresholds according to an embodiment of the present invention. As shown, the current resource usage data may be input to or calculated at the usage rate controller. The usage rate controller may similarly receive as input or calculate the statistics of video input, the encoding time, and the video encoder internal states received. The data to calculate encoder related values may be received as feedback from the components of the encoder, for example, the video input data and statistics may be received from a pre-processor. Data concerning the coding modes, frame complexity, motion estimations, and coding latency may be received as feedback from the coding engine.

The method 500 may initially determine a target usage rate (block 505). The target usage rate may be input into the rate usage controller or may be calculated at the rate usage controller with reference to the input current resource usage. For example, if the current resource usage data indicates that resource usage is near capacity or otherwise exceeding a predetermined threshold, the rate usage controller may set the target usage rate below the current resource rate. Or, if the current resource usage data indicates that resource usage is below capacity or otherwise below a predetermined threshold, the rate usage controller may leave the target usage rate unchanged or set the target usage rate above the current resource rate, allowing the encoder to utilize additional resources.

Once the target usage rate is identified, a target parameter may be calculated (block 510). The target parameter may be calculated with reference to the current rate usage data and the current thresholds. The target parameter may be calculated to adjust a coding parameter such that if the parameter is set to the target parameter, the encoder's usage of the resource may be changed. For example, where the usage rate controller attempts to decrease resource usage, the target parameter may be set to decrease coding complexity. Then the target parameter may be compared to the current parameter thresholds (block 515). If the current parameter already satisfies the current parameter thresholds (block 520), then setting the parameter at the current parameter threshold will have no impact on the resource usage. A new target parameter may be calculated to further limit resource usage by the encoder (block 510). If the target parameter does not satisfy the current parameter threshold (block 520), the parameter thresholds may be adjusted to reflect the target parameter (block 525). The parameter thresholds may then be output to the encoder.

According to an embodiment of the present invention, the rate usage controller may set the individual coding parameters, not just the parameter thresholds. Setting a coding parameter may cause the encoder's usage of the resources to be decreased or otherwise limited, for example, the rate usage controller may set the frame rate or quantization parameter for the video encoder. Such direct parameter setting may limit the encoder's use of the system resources but may conflict with or be overwritten by later operations of the encoder. For example, the quantization parameter may be set by a bit rate controller or the pixel block size may be set by a coding mode decision based on the motion calculated for the frame at the coding engine. Then the parameter conflict will need to be resolved.

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 2 illustrates the components of the encoder such as the rate usage controller 204 and the bit rate controller 206 as separate units, in one or more embodiments, some or all of them may be integrated and they need not be separate units. Such implementation details are immaterial to the operation of the present invention unless otherwise noted above.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A video coding method comprising:
monitoring an encoder's resource usage; and
upon detection of a change in the resource usage, setting a video coding parameter to control the resource usage to meet a resource usage requirement.

2. The method of claim 1 wherein the parameter is fixed for a plurality of pixel blocks.

3. The method of claim 1 wherein the parameter is fixed for a frame.

4. The method of claim 1 wherein the parameter is fixed for a frame sequence.

5. The method of claim 1 wherein the video coding parameter sets a frame rate of the encoder.

6. The method of claim 1 wherein the video coding parameter sets a quantization parameter of the encoder.

7. The method of claim 1 wherein the video coding parameter sets a frame resolution of the encoder.

8. The method of claim 1 wherein the video coding parameter sets a bit rate of the encoder.

9. The method of claim 1 wherein the video coding parameter sets a pixel block size of the encoder.

10. The method of claim 1 wherein the video coding parameter sets a predictive pixel block coding technique of the encoder.

11. The method of claim 1 further comprising setting a plurality of video coding parameters to control the resource usage to meet a resource usage requirement.

12. The method of claim 1 wherein monitoring the resource usage comprises monitoring power consumption.

13. The method of claim 1 wherein monitoring the resource usage comprises monitoring CPU usage.

14. The method of claim 1 wherein monitoring the resource usage comprises monitoring fan speed.

15. The method of claim 1 wherein monitoring the resource usage comprises monitoring battery status.

16. The method of claim 1 wherein monitoring the resource usage comprises monitoring video coding latency.

17. A video coding method comprising:
calculating, with a current value for usage of a resource in an encoder and a target value for usage of the resource in the encoder, a target threshold for a video coding parameter; and
passing the target threshold to a coding engine to set the coding parameter within the target threshold;
wherein the set parameter changes the usage of the resource.

18. The method of claim 17 wherein the current value reflects an internal state of the encoder.

19. The method of claim 17 wherein the video coding parameter influences a coding mode decision.

20. A video coding system comprising:
a controller to monitor resource usage of an encoder in the video coding system, to calculate a change in the resource usage, and to calculate a new video coding parameter responsive to the change; and
a coding engine to create coded pixel blocks by coding an original pixel block according to the new video coding parameter.

21. The system of claim 20 wherein the resource usage reflects a latency of the coding engine.

22. The system of claim 20 wherein the resource usage reflects an internal state of the encoder.

23. The system of claim 20 wherein the video coding parameter influences a coding mode decision.

24. The system of claim 20 wherein the video coding parameter influences coding complexity in the coding engine.

25. The system of claim 20 wherein the video coding parameter is calculated to change resource usage by the encoder.

26. A video coding system comprising:
a controller to monitor resource usage in an encoder of the video coding system, to calculate a change in the resource usage, and to calculate a new video coding parameter threshold responsive to the change; and
a coding engine to set a video coding parameter within the threshold and to create coded pixel blocks by coding an original pixel block according to the video coding parameter.

27. The system of claim 26 wherein the resource usage comprises power consumption.

28. The system of claim 26 wherein the resource usage comprises CPU usage.

29. The system of claim 26 wherein the resource usage comprises battery status.

30. The system of claim 26 wherein the coding parameter comprises a bit rate.

31. The system of claim 26 wherein the coding parameter comprises a frame rate.

32. The system of claim 26 wherein the coding parameter comprises a quantization parameter.

33. The system of claim 26 wherein the coding parameter comprises a pixel block size.

34. The system of claim 26 wherein the coding parameter comprises a frame rate.

35. The system of claim 26 wherein the coding parameter influences a coding complexity of the coding engine.
